(19) United States
(12) Patent Application Publication
(10) Pub. No.: US 2012/0109868 A1
(43) Pub. Date: May 3, 2012

(54) Real-Time Adaptive Output

(75) Inventors: Oscar E. Murillo, Redmond, WA (US); Janet E. Galore, Seattle, WA (US); Jonathan C. Cluts, Sammamish, WA (US); Colleen G. Estrada, Medina, WA (US); Tim Wantland, Seattle, WA (US); Blaise H. Aguera-Arcas, Seattle, WA (US)

(73) Assignee: Microsoft Corporation, Redmond, WA (US)

(21) Appl. No.: 12/917,340

(22) Filed: Nov. 1, 2010

(51) Int. Cl. G06N 5/04

(52) U.S. Cl. 706/46

(57) ABSTRACT

The subject disclosure relates to a technology by which output data in the form of audio, visual, haptic, and/or other output is automatically selected and tailored by a system, including adapting in real time, to address one or more users' specific needs, context and implicit/explicit intent. State data and preference data are input into a real time adaptive output system that uses the data to select among output modalities, e.g., to change output mechanisms, add/remove output mechanisms, and/or change rendering characteristics. The output may be rendered on one or more output mechanisms to a single user or multiple users, including via a remote output mechanism.

### BACKGROUND

In existing computing interfaces, the output modality is typically fixed, and needs to be explicitly chosen or changed by the user, such as to adjust to a changed need or situation. For example, if a person is on a private phone call in which the audio comes through a computer's speakers, and another person walks in, the user must take an action to protect privacy, such as to mute the sound or switch to using a headset. In general, the system has no ability to automatically provide the user with options or change the output method.

As users deal with more and more computing concepts and resources, such as cloud computing, devices with more computing power and more sensing technologies, and more interactive displays in public places, users have more options than ever for receiving output. At different times, users want to use different output modalities and have output customized for a desirable end-user experience. However, known technologies do not help users with the selection. What is desirable is output that naturally adapts to a user's implicit or explicit intent and/or a user's real-time environmental conditions (e.g., noise level, light level, presence of other people, presence of other output devices, location and so forth).

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which output data in the form of audio, visual, haptic, and/or other output is automatically selected and tailored by a system, including adapting in real time, to address one or more users' specific needs, context and implicit/explicit intent. To this end, state data along with preference data may be input into a real time adaptive output system. The system selects an output modality or modalities based upon the state data and the preference data, and outputs data corresponding to the selected modality or modalities. The system monitors for a change to the state data to adapt the output modality or modalities based upon a suitable change to the state data.

The output may be rendered on a single output mechanism to a single user, may be a computed consensus output modality based upon the preferences of a plurality of users, or may be rendered via different output mechanisms to different users. To adapt the output modality, the system may change (e.g., add, remove and/or switch) one or more output mechanisms that are in use, and/or may change rendering characteristics (e.g., volume, display properties and so forth) of the output data.

In one implementation, an adaptive output system includes a plurality of output mechanisms that are each available to render output data corresponding to an output modality, an output processor configured to process raw data into output data corresponding to one or more output modalities, and a recommendation engine configured to adaptively determine, based upon state data, one or more intended output modalities according to which the output data is rendered. An intended output modality may correspond to a local or remote output mechanism, and both local and remote output mechanisms may be used. A personalization engine may provide personalization information that the recommendation engine uses in determining the intended output modality. A conversion mechanism may be used to convert raw data or output data in one format to output data in another format.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components of a real-time adaptive output system.

FIG. 2 is representation of one implementation of an architecture suitable for use with a real-time adaptive output system.

FIG. 3 is a representation of local and remote output devices that may be adaptively used and controlled by communicating information through a suitable connection.

FIG. 4 is a flow diagram showing example steps that may be performed by a real-time adaptive output system.

FIG. 5 shows an illustrative example of a computing environment into which various aspects of the present invention may be incorporated.

### DETAILED DESCRIPTION

Various aspects of the technology described herein are generally directed towards a technology by which computer sensors detect various conditions (e.g., state data), which are then processed (typically along with other data) to determine what output modality or modalities are intended/desired by a user or set of users. In this manner, the output provided by one or more computing systems automatically and fluidly adapts to the user's or users' current situation.

It should be understood that any of the examples herein are non-limiting. For example, while a computer system, mobile device (e.g., Smartphone), telephone devices and so forth are described as examples of systems that can implement real-time adaptive output, devices other than those exemplified may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and user interfaces in general.

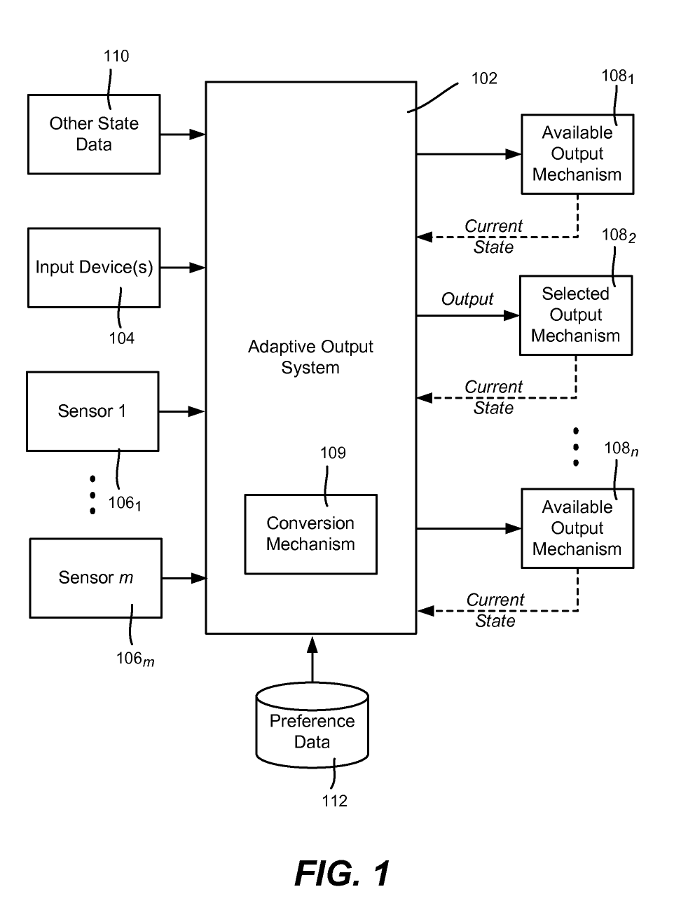

FIG. 1 shows example components of an adaptive output system 102, in which one or more input devices 104 and sensors 106₁-106ₘ provide various input state data to the adaptive output system 102. The adaptive output system 102 may be implemented for an entire computing system/device. In one alternative, a program may implement its own adaptive output system; for example, a suite of applications such as Microsoft® Office may be provided that incorporates or interfaces with an adaptive output system. In another alternative, the adaptive output system 102 may be a component of a larger intention judgment system, or work in conjunction with a larger intention engine.

As described below, based upon this state data and possibly other information, the adaptive output system 102 selects one or more available output mechanisms 108₁-108ₙ, and sends data thereto to output to the user or users. For example, whether a user is typing or speaking may be used as factors in determining the output, as may whether one user or multiple users are to be presented with the output. The rendering of the output may include appropriate conversion or other formatting of the data and other characteristics of the output (e.g., audio volume), if necessary, as represented by conversion mechanism(s) 109. Note that which output mechanisms 108₁-108ₙ are currently available is also part of the selection process.

The sensors 106₁-106ₘ provide environmental data and/or other sensed data to the adaptive output system 102. More particularly, a computer system has the ability to gather detailed information about its environment and the user or users interacting with the system. Examples of ways to sense such data include via computer vision, microphones, accelerometers, compasses, clocks, GPS, thermometers, humidity sensors, light sensors, infrared sensors, depth sensors, entity extraction and so forth. These can sense environmental and other data, such as current room and/or device temperature, whether the user is moving and at what speed, whether the user is alone or with someone else, the amount of ambient light, computer-related or output device-related data (e.g., device battery life, available power, running programs and services), and so forth.

Further, systems can detect information about their own states and the presence and states of other devices via internal or other systems, as represented in FIG. 1 via other state data 110. Examples include the presence of Wi-Fi, Bluetooth, and other mesh or local area network technologies, and permission states, e.g., whether the user has authority to utilize such devices. The knowledge of which output mechanisms are currently available for rendering output, e.g., 2D and 3D displays, multi-person displays, gestural displays, printers, kinetic displays, speakers, headphones, mobile devices, other peripherals, public displays, displays of other devices also may serve as input to the system. Still other state data 110 known to a computer system includes information about a user's tasks and intent in real-time through a variety of means, including window focus, use of input modalities, social network activities, login/authentication state, information being exchanged with other systems, language being used, running programs, live connections to other services and so forth. Yet another example of such other state data 110 that may be input into the adaptive output system 102 may include a user-selected operating mode/override, such as to specify using a device in a different way (e.g., using a digitizer to input gestures instead of handwriting).

In addition to state data, a system can also use custom and/or existing or predefined (e.g., default) user profile information, represented in FIG. 1 as preference data 112, to establish likely output defaults. These may include accessibility options, language, default location, and device preferences and settings.

In general, the adaptive output system 102 processes the various input data and the user preference data 112 to regularly (e.g., continuously) determine the intent of the user or users as to what output mechanism or mechanisms 108₁-108ₙ of those available are most desirable to the user or users. Example output mechanisms correspond to a display screen, projection, holographic video or I/O display, speech or other audio through speakers, headset or bone conduction, haptics, smell, position/kinetics (e.g., of robot), proximity, asynchronous communications such as email or text message. Multiple simultaneous outputs (e.g., visual/haptic, visual/aural) or any other combination may be used.

Further, in addition to output mechanism selection, the adaptive output system 102 can determine how to render the output on a given mechanism, e.g., to tailor the output characteristics to current conditions and/or situations. Output rendering options include selecting display colors and/or brightness, resolution, aspect ratio, the volume of audio output, language, literacy level (e.g., different vernacular, phrasing, dictionary and the like), speed of output (e.g., speaking more slowly to a child), and so forth.

Consider the above example of a person on a private phone call on speakerphone in her office. If another person walks in, the adaptive output system 102 detects this state change, and can adapt the call by automatically muting it or switching it from speakerphone to a headset or earpiece, such as according to a user-specified preference or default preference as maintained in the preference data 112. As another example, if a person reading content on a tablet changes his or her state to drive a car, and wants to continue to interact with the content while driving, the adaptive output system 102 may automatically switch to using speech instead of a visual display of the content. If a user has low literacy skills, the system can automatically adapt the content of news articles or websites to the user's reading level.

Another aspect of the adaptive output system 102 is directed towards adapting output to address the needs of more than one user (e.g., consensus output). For example, the system may calculate an optimal output for each individual user, take into account the tasks being done at the time, and apply an algorithm to find an optimal solution that maximizes (or e.g., averages) preference indices across the group constrained by the tasks being done. One user may receive one type of output, e.g., text, while another user may receive another type of output, e.g., speech. The output may be over local and/or remote devices, e.g., one user may read test output on a local display while another user hears the text-to-speech equivalent of that output on a remote Smartphone. In an alternative scenario, for tasks that are driven by one leader, the system may ask the group to designate a leader, or may suggest a group leader. If there are independent tasks being done by individuals in the same location, the system may employ a time and space sharing algorithm that takes into account the equality or inequality of each of the participants and their tasks, and load balances the optimal outputs accordingly. Each of these may be considered consensus output.

Note that existing systems allow for users to take manual actions to make a change to output, or allow for preset accessibility options which the system will apply to a logged in user, but these settings are chosen beforehand. They are thus not automated, or are all-or-nothing configuration settings that are not adaptive to state data changes in real time. Moreover, they do not migrate to other systems based on the user profile.

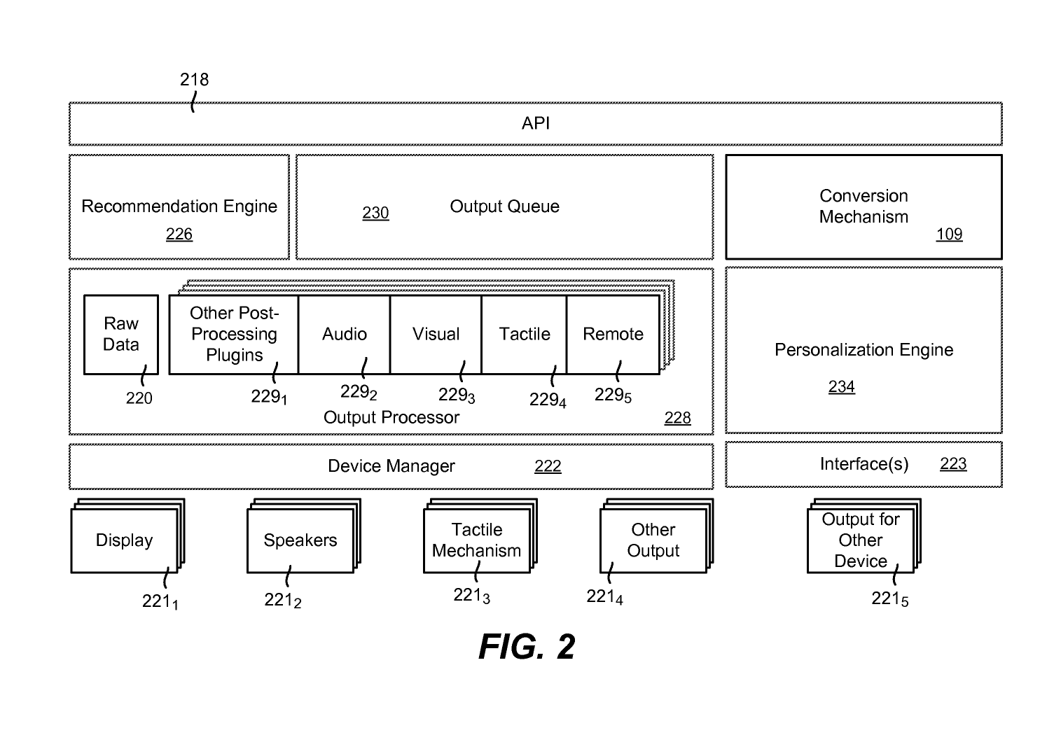

FIG. 2 is an architectural diagram showing one example embodiment of adaptive output system 102, which may be coupled to a program (e.g., application or operating system component) via an API 218 that provides the output as raw data 220. The raw data 220 may be time stamped for synchronization purposes. In FIG. 2, a set of one or more displays, speakers, tactile/haptic mechanisms (e.g., a vibrating phone) and “other” are shown as the output devices 221₁-221₄, respectively, that correspond to possible output modalities. The various output mechanisms 221₁-221₄ may couple to the system 102 via at least one device manager 222. Note that to accommodate the possibility of multiple output mechanisms/multiple users, each output mechanism 221₁-221₄ is represented by multiple blocks in FIG. 2, although it is understood that not all represented devices need be present in a given configuration, or that more output mechanisms or different output mechanisms than those shown in the examples shown may be present.

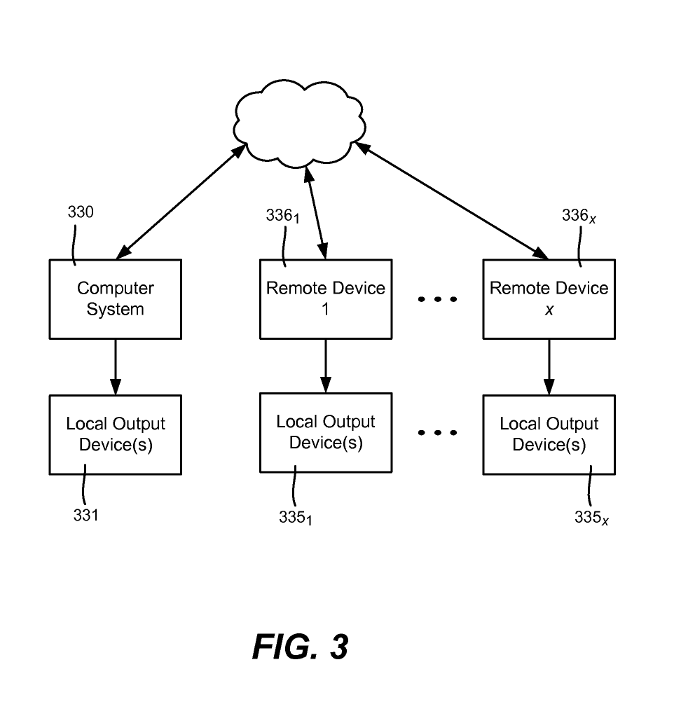

Also represented in FIG. 2 is output 221₅ for one or more other devices, whether for the same user or a different user, which couple to the system through one or more suitable interfaces 223. For example, output 221₅ can be generated from a master computer, which is then customized and rendered on one or more various other local or remote devices (e.g., as shown in FIG. 3), as desired. In other words, intent can be interpreted on local/master computer system or a slave computer system, with output generated from the master, and customized and rendered on various local or remote devices. Multi-user intent can be interpreted on master or slave devices, and output can be rendered to slave devices as well.

A recommendation engine 226 processes the various input information/state data and makes a recommendation as to what each user likely intends with respect to what output modality or modalities are desired. An output processor 228, which may be hard-coded to an extent and/or include plug-ins 229₁-229₅ for handling the output data of various modalities, processes the raw data 218 into formatted output data, as needed, which may be queued in an output event queue 230 for synchronization purposes. As shown in FIG. 2, other post-processing plugins (or hardcoded code), along with audio, visual, tactile and remote (e.g., networking) components 229₁-229₅ are shown as examples, respectively, however it is understood that not all represented components need be present in a given configuration, or that more components or different components than those shown in the example may be present.

As part of the processing and queuing, the output processor 228 may communicate with a personalization engine 234, which, as described above, may access preference data 112 and other information to select an output mechanism or mechanisms, as well as format the data for a user or multiple users. This may include changing the output characteristics to provide the desired output modality or modalities to the selected output mechanism or mechanisms. The output may be to one user, over one or more modalities, and may be to multiple users, including over different modalities to different users.

The conversion mechanism 109 may include a text-to-speech engine, speech-to-text engine, dictionaries, entity extraction engines (e.g., to process still images, video, or 3D visuals to convert what is being shown to text or speech), and so forth to format/convert the raw data 220 to the desired output format. For example, the personalization engine 234 may access a custom speech dictionary that is used by the conversion mechanism 109 to convert audio data to text, with the text then queued for output.

Note that the recommendation engine 226 may not necessarily determine the output directly, but in one alternative, may process the data in the output queue 230 only to make recommendations to a program that consumes the queued data. For example, the output data may be provided in a variety of formats and types to a program, with the recommendation engine 226 only suggesting which type of output modality is likely desired. This allows a program or device to override a suggestion, such as on specific request of the user through that program or device.

Note that the system or a receiving program may forward the recommendations to another program. For example, the receiving program may route the recommendations to a remote device, which may choose to use them or not. Consider an example where text and speech is routed to a cell phone that is in a silent mode, with a recommendation that the speech be output; because of the silent mode, the cell phone will only output the text, and buffer or discard the speech data.

FIG. 3 shows how a computer system 330 may output data via its local output device or devices 331, and/or via the output devices 335₁-335ₓ of one or more remote devices 336₁-336ₓ. Any connection, including cloud services, a wired or wireless network, Bluetooth® and so forth may be used to couple devices for exchanging information. Moreover, any of the input information may be shared in the same manner, e.g., a user's personalization data, the state data of a remote device and so forth, may be communicated across devices for use in selecting or recommending output modalities.

Thus, the system enables applications or helps applications to manage multiple output modalities to one or more output mechanisms, to one or more users or groups of users. The output devices may be physically attached or remote, and may be different for different users.

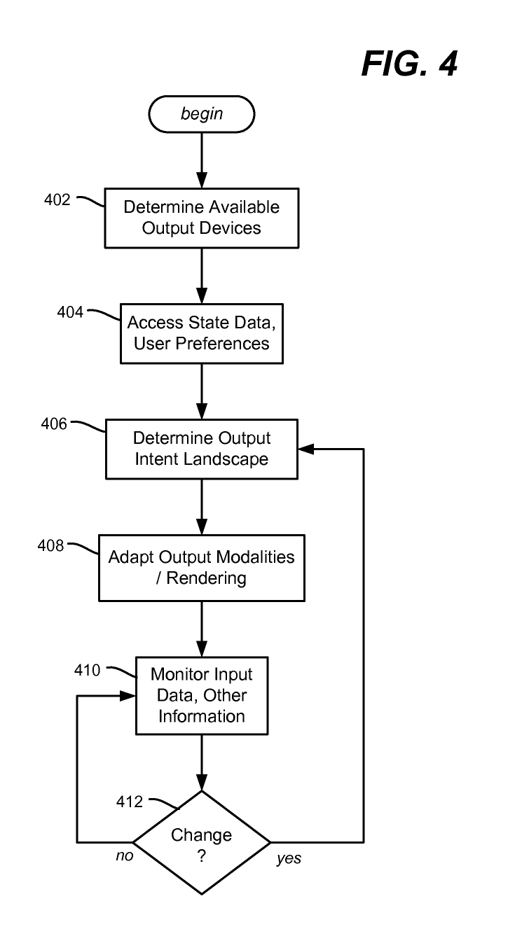

FIG. 4 is a flow diagram representing example steps of a multimodal input system. At step 402, the system determines what output devices/modalities are available. Note that this may be updated at any time, such as by plug-and-play that allows devices to be dynamically connected and/or removed, Bluetooth® discovery, and so forth.

At step 404, the system accesses the available state data and the user preference data. For example, the adaptive output system may first determine the input modalities currently being used, and use existing user profile data to calculate a first guess at what the preferred or most appropriate output or outputs are most likely to be. For example, if a user is typing and there is a desktop monitor and speakers present, it is likely that the visual display and speakers will be the best output.

Based on the initial data, in one implementation the system forms a baseline model, referred to herein as the “user-environment-device-intent landscape” (step 406). There may be a baseline model per user. As described above, this may include the social situation/presence of others, e.g., whether the user is alone or not, or with family, friends, co-workers or unknown people, (such as determined by facial recognition, for example.) This may also include the user's current environment, e.g., in a room, outdoors, on a train, at home, at work, at school, in a hospital, and so forth. The user's geospatial location, explicit and implicit inputs (e.g., what input devices are nearby and being used or not used), the task at hand, the motion (moving or not), time of day, language data may further be evaluated. Still further, other external variables may be considered, such as in a library system that has a no talking rule.

From this information, the adaptive output system creates the user-environment-device-intent landscape that represents each user's intent, as determined by the recommendation engine and/or inferred by user activities, applications, and communications. The system then adapts the output modalities and rendering to match the user's or users' likely intent with respect to receiving output information. Note that the intent may be based on a consensus computation or the like as described above.

At step 410, the system thereafter monitors the state data of the internal and external information sources to update the landscape model in real-time, using reasoning (e.g., based on training) to adapt output modalities including device selection and rendering as needed to optimize the user experience. Note that in the flow diagram, step 412 represents determining whether a change is sufficient enough to return to step 406 to re-determine the intent. For example, a driver may slow down, but this state change is not sufficient to re-compute the landscape model for that user.

In this manner, a computing system may determine one or more optimal output modalities in real-time, across devices, users, and situations. This is based upon a variety of information about the user, such as the user's environment, where the user is looking, devices nearby, existing input and available output modalities, social situation, geospatial location, presence of others, task at hand, physical motion, time of day, language, and other external variables, which are processed to determine the most optimal output modality or modalities (mechanisms and modes for rendering) from the system. The system can adaptively render the output to the optimal locations in the optimal way for ease of use, as appropriate to each user's situation, and adapt as the situation and users or other state changes in real-time.

### Exemplary Operating Environment

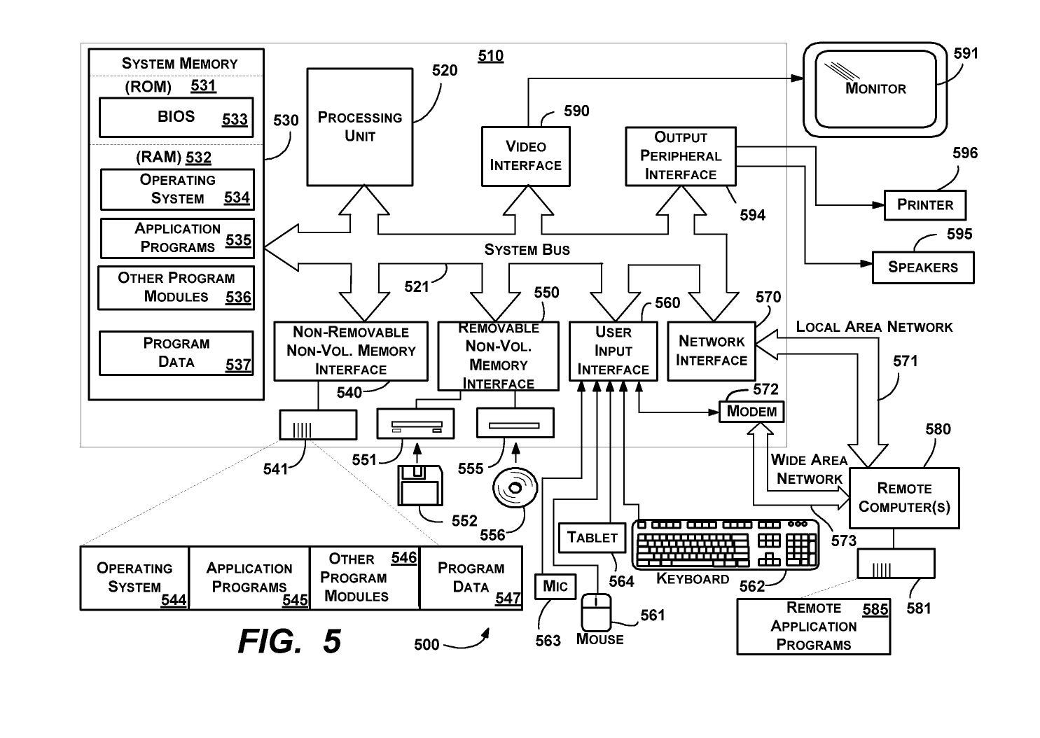

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, inputting state data, inputting preference data, selecting an output modality or modalities based upon the state data and the preference data, outputting data corresponding to the selected modality or modalities, monitoring for a change to the state data, and adapting in real time the output modality or modalities based on a change to the state data.

2. The method of claim 1 wherein outputting the data comprises rendering data via at least one output mechanism to a single user.

3. The method of claim 1 further comprising, determining a consensus output modality for a plurality of users, and wherein outputting the data comprises rendering data via an output mechanism to the plurality of users according to the consensus output modality.

4. The method of claim 1 wherein outputting the data comprises rendering data via a different output mechanisms to different users.

5. The method of claim 1 wherein inputting the state data comprises receiving data obtained by at least one sensor.

6. The method of claim 1 wherein adapting the output modality or modalities comprises selecting a different output mechanism based on the change to the state data.

7. The method of claim 1 wherein outputting the data comprises rendering the data via a first output mechanism, and wherein adapting the output modality or modalities comprises selecting a second output mechanism based on the change to the state data and rendering the data via the second output mechanism.

8. The method of claim 1 wherein outputting the data comprises rendering the data with a first set of one or more characteristics, and wherein adapting the output modality or modalities comprises rendering the data with a second set of one or more characteristics, in which at least one characteristic of the second set is different from a characteristic of the first set.

9. In a computing environment, a system, comprising:
a plurality of output mechanisms that are each available to render output data corresponding to an output modality;
an output processor configured to process raw data into output data corresponding to one or more output modalities; and
a recommendation engine configured to adaptively determine, based upon state data, one or more intended output modalities according to which the output data is rendered.

10. The system of claim 9 wherein at least one intended output modality corresponds to a local output mechanism, and wherein at least one other intended output modality corresponds to a remote output mechanism.

11. The system of claim 9 wherein the output processor includes an audio processing component, a visual processing component, a tactile processing component, or a remote processing component, or any combination of an audio processing component, a visual processing component, a tactile processing component, or a remote processing component.

12. The system of claim 9 further comprising a personalization engine configured to communicate with the recommendation engine to provide personalization information that the recommendation engine uses in determining the intended output modality.

13. The system of claim 9 further comprising a conversion mechanism configured to convert raw data or output data in one format to output data in another format.

14. The system of claim 9 further comprising at least one sensor that provides at least part of the state data.

15. The system of claim 9 wherein the state data comprises environmental data, computer-related data, output device-related data, input device data, network-related data or external device-related data, or any combination of environmental data, computer-related data, output device-related data, input device data, network-related data or external device-related data.

16. The system of claim 9 wherein the recommendation engine is configured to use preference data in determining the intended output modality.

17. One or more computer-readable media having computer-executable instructions, which when executed perform steps, comprising:
outputting output data corresponding to one or more output modalities;
detecting a change in state data; and
adapting to the change in state data by changing at least one output modality, including adding a new output mechanism, switching to a different output mechanism, or changing rendering characteristics of at least some of the output data, or any combination of adding a new output mechanism, switching to a different output mechanism, or changing rendering characteristics of at least some of the output data.

18. The one or more computer-readable media of claim 17 wherein outputting the output data comprises providing the output data from a master computer system, and having further computer-executable instructions comprising, customizing the output data for rendering on an output mechanism of a different computer system.

19. The one or more computer-readable media of claim 17 having further computer-executable instructions comprising, accessing preference data to adapt to the change in state data.

20. The one or more computer-readable media of claim 17 wherein detecting the change in state data comprises detecting presence of another user, and having further computer-executable instructions comprising, accessing preference data of the other user to adapt to the change in state data.
